(19) United States
(12) Patent Application Publication
(10) Pub. No.: US 2019/0118573 A1
(43) Pub. Date: Apr. 25, 2019

(54) ERASER FOR DRY ERASE BOARDS

(71) Applicant: ACCO Brands Corporation, Lake Zurich, IL (US)

(72) Inventors: Thomas A. Nelson, JR., Naperville, IL (US); Jason B. Magid, Wheeling, IL (US); Richard A. McCallion, Glencoe, IL (US); Bryan J. Poteracki, Volo, IL (US)

(21) Appl. No.: 16/012,084

(22) Filed: Jun. 19, 2018

Related U.S. Application Data
(60) Provisional application No. 62/574,939, filed on Oct. 20, 2017.

(51) Int. Cl. B43L 19/00

(52) U.S. Cl. CPC B43L 19/00; B43L 21/00

(57) ABSTRACT

A whiteboard eraser includes a first side defining a grip surface, and a second side defining an eraser surface. The eraser surface comprises a reticulated scrubbing portion. The eraser surface may also include a textile wiping portion less abrasive than the reticulated scrubbing portion.

### CROSS-REFERENCE TO RELATED APPLICATIONS

This application claims priority to U.S. Provisional Patent Application No. 62/574,939, filed Oct. 20, 2017, the entire contents of which are incorporated by reference herein.

### BACKGROUND

The present invention relates to erasers for removing ink from a dry erase board, or “whiteboard”. With modern whiteboard materials and markers, ink recently applied to the whiteboard is often simply and cleanly removed with a basic eraser consisting of soft wool or felt material. However, sometimes whiteboards are difficult to erase, and the difficulty increases the longer the marker ink is left on. This often leads to what is referred to as staining or “ghosting”.

### SUMMARY

In one aspect, the invention provides a whiteboard eraser including a first side defining a grip surface and a second side defining an eraser surface. The eraser surface comprises a reticulated scrubbing portion.

In another aspect, the invention provides a whiteboard eraser including a first side defining a grip surface and a second side defining an eraser surface. The eraser surface comprises a textile wiping portion and a reticulated scrubbing portion more abrasive than the textile wiping portion.

Other aspects of the invention will become apparent by consideration of the detailed description and accompanying drawings.

### BRIEF DESCRIPTION OF THE DRAWINGS

FIG. 1 is a front view of a whiteboard eraser according to one embodiment of the invention.

FIG. 2 is a bottom view of the eraser of FIG. 1.

FIG. 3 is an exploded assembly view of the eraser of FIG. 1.

FIG. 4 is a cross-section view of the eraser taken along line 4-4 of FIG. 2.

FIG. 5 is a bottom view of a whiteboard eraser according to another embodiment of the invention.

FIG. 6 is an exploded assembly view of the eraser of FIG. 5.

FIG. 7 a cross-section view of the eraser taken along line 7-7 of FIG. 5.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

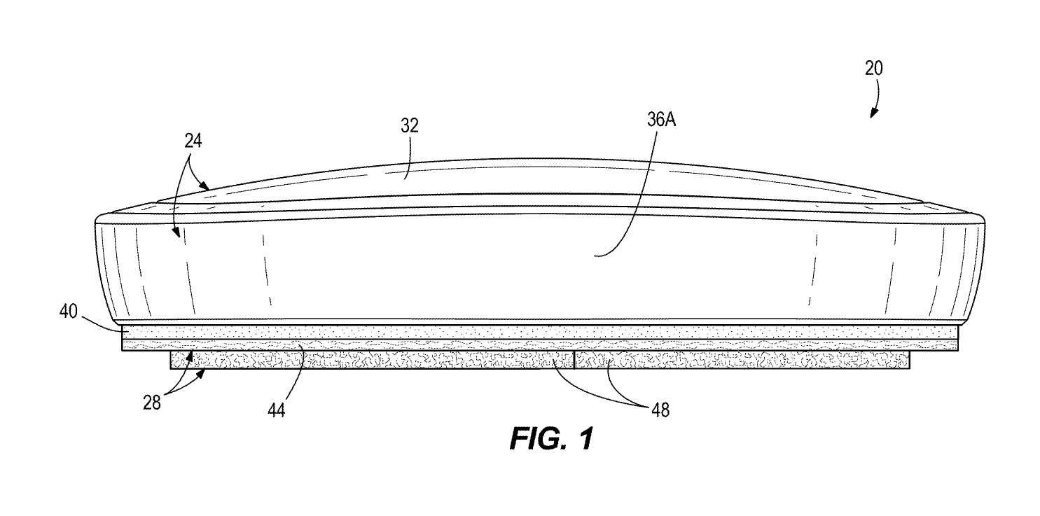

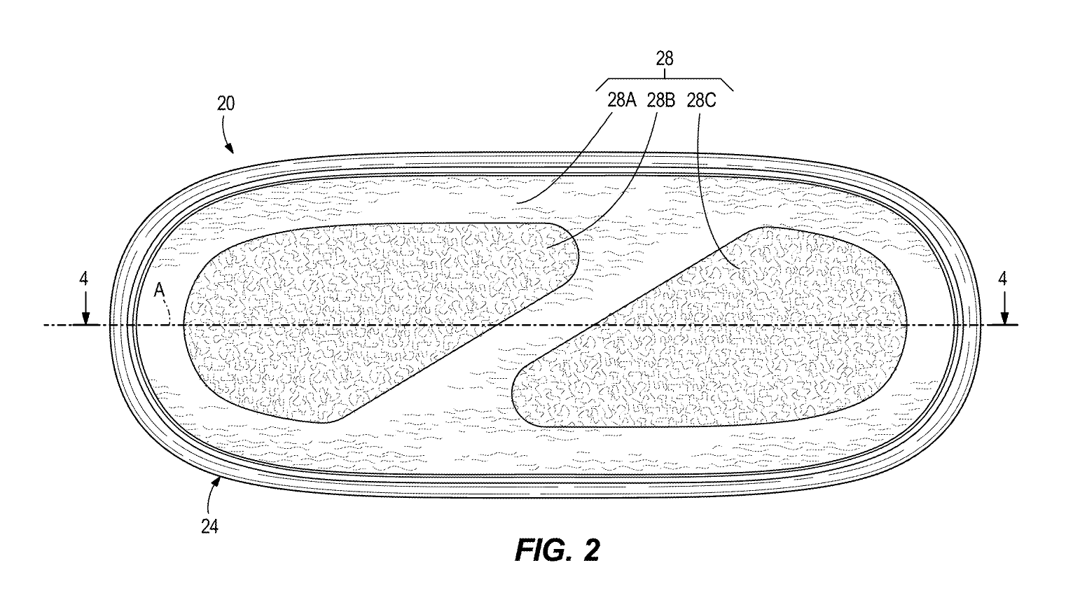

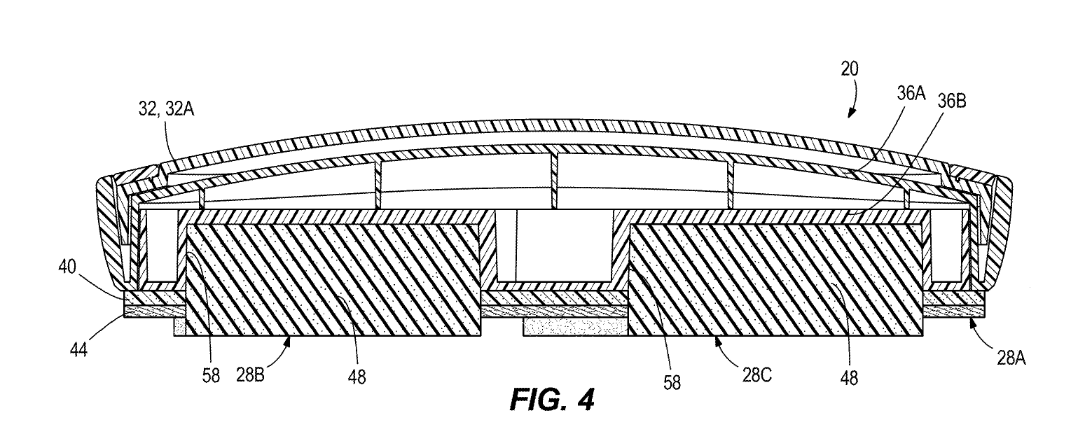

A whiteboard eraser 20 is illustrated in FIGS. 1-4. The eraser 20 includes a first or upper side providing a grip surface 24. The grip surface 24 need not be continuous, and it may encompass all or parts of the exposed surfaces of a top cap 32 and a first or outer housing 36A. The top cap 32 may include multiple materials, and may include a central lens portion 32A that is translucent or transparent. The grip surface 24 can include one or more flat, smooth, or contoured portions adapted to be comfortably grasped by a human hand for manual erasing of ink from a dry erase board (i.e., “whiteboard”). As shown in FIGS. 1, 3, and 4, the grip surface 24 can include a convex portion provided by the top cap 32. A perimeter or border portion of the grip surface 24 can extend around the eraser 20 in the general form of an oval, an ellipse, or a rectangle with rounded corners. However, the grip surface 24 may be provided with any number of different ergonomic shapes. Opposite the first or upper side, the eraser 20 includes a second or working side providing an eraser surface 28. The perimeter portion of the grip surface 24 may taper toward the eraser surface 28 as best shown in FIG. 4. The bottom view of FIG. 2 is directed at the eraser surface 28, which is described in particular detail below. As can be observed from FIGS. 1 and 4, the eraser surface 28 need not be continuous, and may in fact be constituted by separate, discontinuous surface portions.

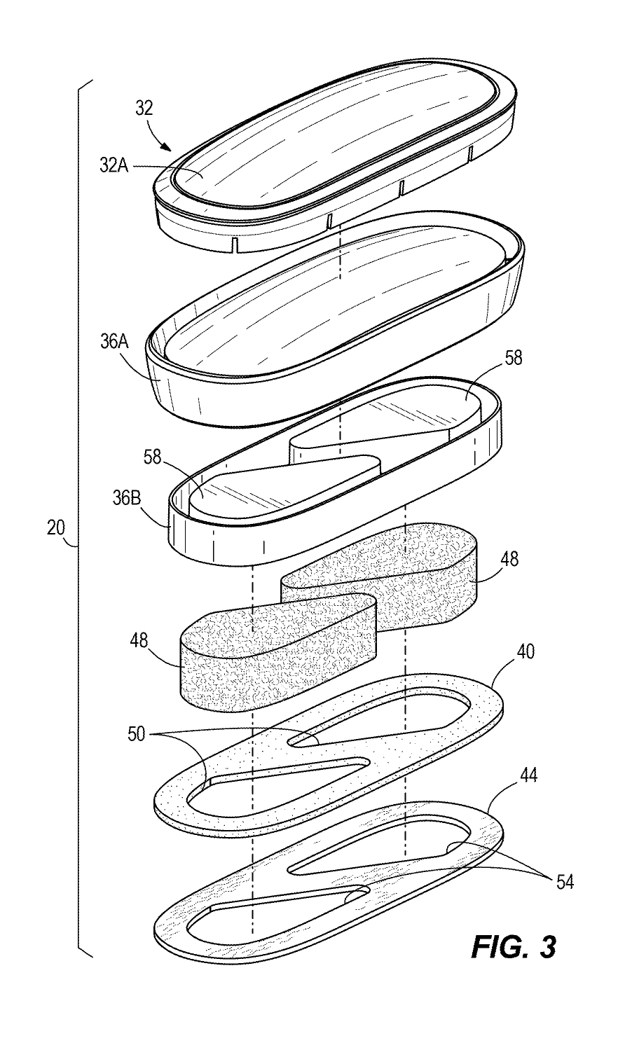

With reference to FIG. 2, the eraser surface 28 includes multiple zones or areas 28A, 28B, 28C, which include multiple materials. In other words, the eraser surface 28 is not of a uniform construction. More particularly, the eraser surface 28 of the eraser 20 includes two different materials amongst the zones 28A to 28C: a first material 44 that is soft and a second material 48 that is harder and/or more abrasive. In some constructions, the first material 44 is present in the first zone 28A and the second material 48 is present in the second and third zones 28B, 28C. The first zone 28A may form a perimeter of the eraser surface 28. Also, the second and third zones 28B, 28C can be subdivided by between the first zone 28A. Although numerous different zone arrangements are optional, the illustrated construction provides the second and third zones 28B, 28C as irregular teardrop-shapes that are separated from each other by a strip of the first zone 28A, e.g., coextensive with the perimeter part of the first zone 28A, that runs diagonally therebetween. The dividing strip of the first zone 28A is skewed with respect to a primary elongation axis A of the eraser 20. In some constructions, the second and/or third zones 28B, 28C of the second material 48 defines a face(s) that protrudes from a face defined by the first zone 28A having the first material 44. This can be seen in FIGS. 1 and 4. However, it is noted that one or both of the first and second materials 44, 48 can be compressible with pressure applied against a whiteboard during use, and the above described protrusion may refer to the at-rest state of the eraser 20. In constructing the eraser 20, the first material 44, which may be cut from a sheet into the desired form, can be bonded to a second or inner housing 36B, e.g., with adhesive. In the illustrated example, a cushion layer 40 is provided between the first material 44 and a surface of the inner housing 36B as shown in FIGS. 1, 3, and 4. The cushion layer 40 (e.g., foam such as EVA foam) can have adhesive applied on both sides to bond the first material 44 to the surface of the inner housing 36B. The cushion layer 40 can be configured to provide a desired response or feel to the user as s/he applies pressure via the grip surface 24 during erasing. The cushion layer 40 provides a damping or cushioning effect, which may not be possible from the outer/inner housings 36A, 36B, as these may be comparatively rigid (e.g., hard plastic, such as ABS). As shown in FIG. 3, the cushion layer 40 and the first material 44 may be formed with respective apertures or windows 50, 54 for receiving the second material 48. The inner housing 36B may fit partially or fully into the outer housing 36A and may be retained there by suitable means, such as adhesive, a snap-fit, etc. Each portion of the second material 48, which may be shaped in-form, or alternately cut to shape as a sheet or block, can be partially received into a respective pocket 58 provided in the inner housing 36B. The second material 48 can be retained within the pockets 58 by a suitable fastener or adhesive.

As mentioned above, the first material 44 is softer than the second material 48. The first material 44 can be a textile and particularly a fabric such that the zone(s) (e.g., first zone 28A) having the first material 44 form one or more textile wiping portions. The first material 44 can include, exclusively or as part of a combination or blend, wool fibers, for example, in the form of felt. However, these or other textile fibers can be provided in various other forms among alternate variations. For example, in combination with or in lieu of wool, the first material 44 can include other natural or synthetic fibers in some constructions. As mentioned above, the first material 44 can be in the form of a textile and particularly a fabric, and this refers to the configuration or construction of the material as used in the first zone 28A of the eraser surface 28. The second material 48 is a relatively harder and/or more abrasive material than the first material 44. As such, the zone(s) (e.g., second and third zones 28B, 28C) having the second material 48 form one or more scrubbing portions. The second material 48 can include, exclusively or as part of a combination or blend, any number of plastics or elastomers. These can include semi-soft plastics such as polypropylene, polyethylene, polyurethane (polyester urethane, polyether urethane), or nylon (polyamide). The second material 48 can have a hardness of 20-95 Shore A and/or 40-120 Rockwell R. In some constructions, the second material 48 has a hardness value of 30-80 Shore A. Further examples of the second material 48 can include: acetal, acrylic, acrylonitrile butadiene styrene (ABS), acrylonitrile styrene acrylate (ASA), epoxy, fluoropolymer, liquid crystal polymer, phenolic, polycarbonate, polyester, polyether imide, polyetherketone, polyimide, polyolefin, polyphenylene oxide, polyphenylene sulfide, polystyrene, polysulfone, polyvinyl chloride (PVC), silicone, styrene acrylonitrile, thermoplastic elastomer, and thermoplastic polyurethane. The configuration or construction of the second material 48 may take a number of forms, some of which are discussed further below.

The second material of the eraser surface 28 can have, in some embodiments, a configuration or construction other than a textile or fabric. For example, the second material may take the form of bristles, tangled strands, one or more wound strands, or the second material may be reticulated such as in a reticulated foam having a net-like structure forming pores therein. As such, the scrubbing portions provided by the second and third zones 28B, 28C may form reticulated scrubbing portions. The second material 48 can be flexible, cell-controlled polyester-urethane foam having a three-dimensional structure of skeletal strands. Examples of some suitable materials are REGICELL foam products available through Woodbridge Foam Partner (WFP) Chattanooga, Tenn. or reticulated filter foam products available through Cleverbrand of Cheektowaga, N.Y. The REGICELL foam products are thermally reticulated polyester, defining various pore counts between 8 and 100 pores per inch. In some constructions, the second material is a plastic of reticulated construction, having a pore count of 5 to 125 pores per inch. In some constructions, the pore count can be 10 to 100 pores per inch. In some constructions, the pore count is not more than 25 pores per inch. For example, the pore count can be about 10 pores per inch (i.e., 7 to 12 pores per inch) or about 20 pores per inch (i.e., 17-23 pores per inch). In some constructions, the pore count is not more than 15 pores per inch. The pore count of the second material 48 can encourage entrainment and entrapment of large quantities of whiteboard marker ink, increasing the service life or cleaning interval of the eraser 20.

In operation of the eraser 20, the second material 48 functions to scrub the ink off the surface of the whiteboard. Although not necessarily required for satisfactory erasing if the ink is relatively fresh, the second material 48 may operate to scrub ink off the whiteboard surface that otherwise cannot be satisfactorily erased by the first material 44. Even in cases where the second material 48 is utilized for scrubbing off ink, the first material 44 can assist in the erasing operation by collecting/capturing loose ink that gets scrubbed off. However, even the second material 48 that is used for scrubbing can also provide an ink capturing effect. For example, the reticulated constructions, among others, can be very porous and thus operable to capture significant quantities of loosened ink within its pores. This effect can significantly add to the life of the eraser 20. For example, a purely felt or wool eraser captures ink and the ink remains primarily on the surface of the felt. Thus, standard erasers dirty quicker and need replacement much more often than an eraser such as that of FIGS. 1-4, or others according to the description herein. Furthermore, the second material 48 of the eraser 20 also helps to scrub the residual release agent left behind from the ink on the surface of the board (known as “ghosting”).

Although certain layouts of zones for the first and second materials 44, 48 are disclosed herein, including the particular embodiment disclosed in FIGS. 1-4, it is explicitly noted that other layouts can be utilized in an eraser as disclosed herein. Some examples include concentric rings, patches or dots provided in a random or grid pattern, zig-zag patterns, alternating rows or strips (straight or wavy), etc. The first and second materials 44, 48 can also be co-manufactured and/or inter-dispersed throughout the entire eraser surface 28.

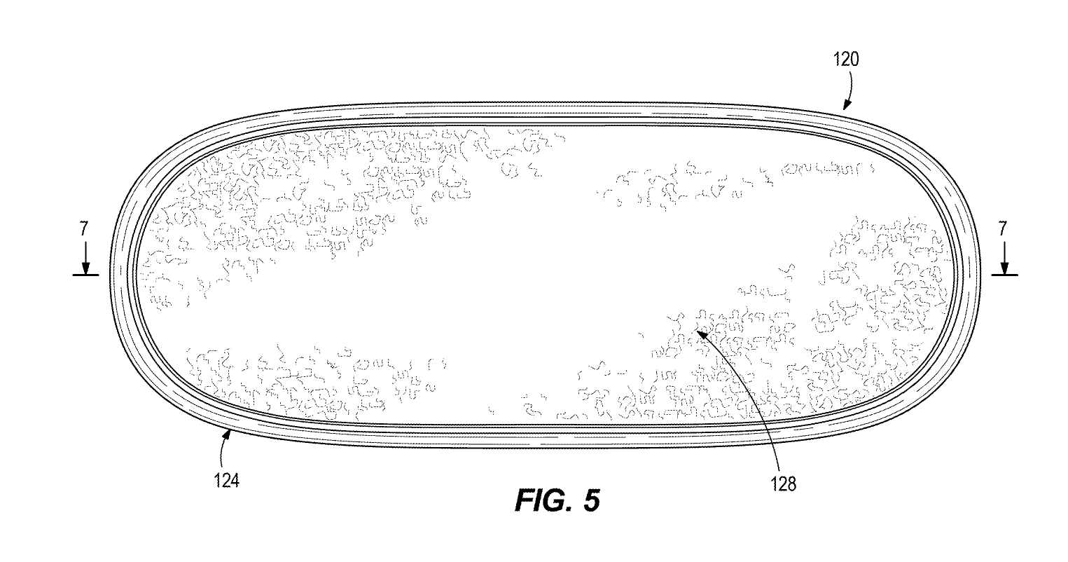

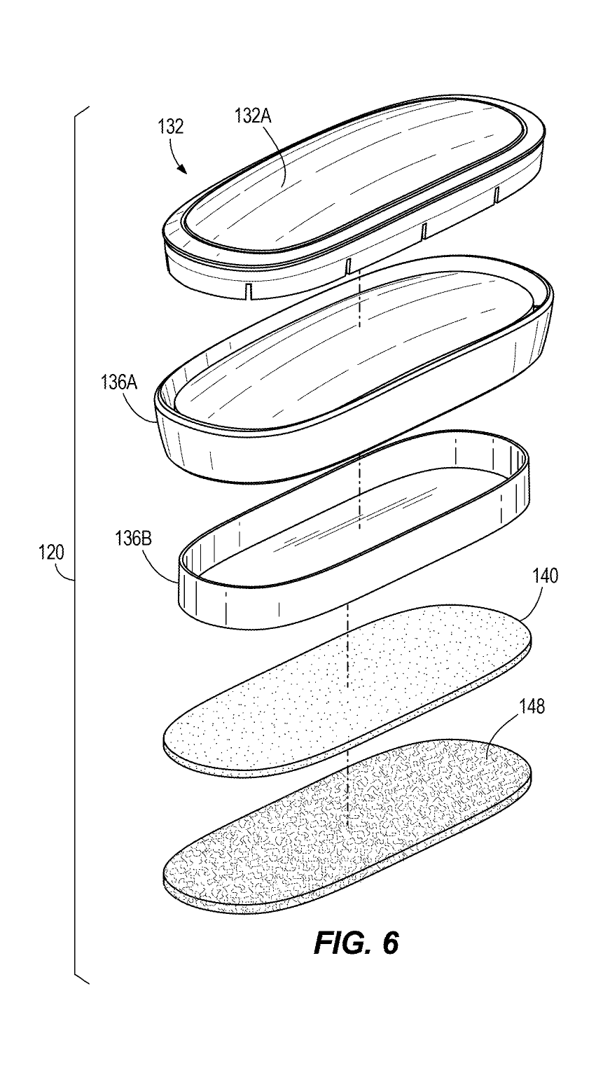

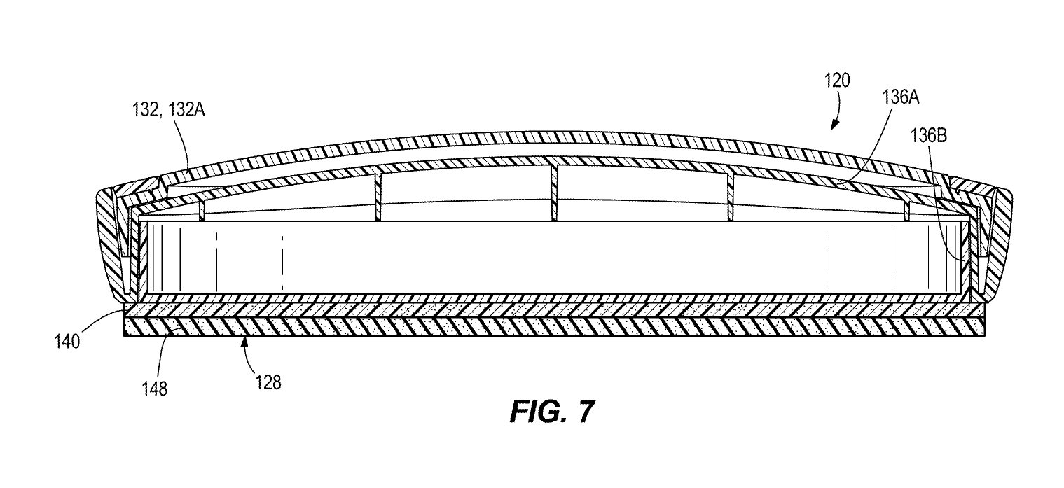

FIGS. 5-7 illustrate an eraser 120 according to another embodiment. Like the eraser 20 of FIGS. 1-4, the eraser 120 includes a first or upper side providing a grip surface 124, an eraser surface 28 on a second or working side, a top cap 132 having a lens portion 132A, an outer housing 136A, and an inner housing 136B at least partially received in the outer housing 136A. Although the grip surface 124 may be provided with any number of different ergonomic shapes, the top cap 132 and the outer housing 136A that make up the grip surface 124 may in fact be identical to the top cap 32 and the outer housing 36A of FIGS. 1-4. However, the inner housing 136B and the eraser surface 128 of the eraser 120 are distinct from their counterparts of the eraser 20 of FIGS. 1-4. As shown in FIGS. 5 and 6, the eraser surface 128 is continuous and consists of a single material 148 (i.e., provided as a single zone). In other words, the eraser surface 128 is of a uniform construction. The material 148 of the eraser surface 128 may be similar to that of the second material 48 described above with respect to the eraser 20 of FIGS. 1-4. Although specific reference is made to the above paragraphs, which provide specific detail with respect to the material and its construction, it is briefly noted that the eraser surface 128 as a whole can form a reticulated scrubbing portion (e.g., of reticulated porous plastic foam).

Various features of the invention are set forth in the following claims.

1. A whiteboard eraser comprising:
a first side defining a grip surface; and
a second side defining an eraser surface,
wherein the eraser surface comprises a reticulated scrubbing portion.

2. The whiteboard eraser of claim 1, wherein the eraser surface further comprises a textile wiping portion that is less abrasive than the reticulated scrubbing portion, and wherein the textile wiping portion and the reticulated scrubbing portion are provided in disparate zones on the eraser surface.

3. The whiteboard eraser of claim 2, wherein the textile wiping portion is constructed of one or more of the materials from the group consisting of: felt, wool, synthetic wool, or microfiber.

4. The whiteboard eraser of claim 3, wherein the reticulated scrubbing portion is constructed of plastic foam material.

5. The whiteboard eraser of claim 2, wherein the disparate zones include a first zone of the textile wiping portion forming a perimeter around a second zone of the reticulated scrubbing portion.

6. The whiteboard eraser of claim 5, wherein the first zone has a greater surface area than the second zone.

7. The whiteboard eraser of claim 2, wherein the reticulated scrubbing portion defines a face that protrudes from a face defined by the textile wiping portion.

8. The whiteboard eraser of claim 1, wherein the reticulated scrubbing portion defines a pore count of 5 to 125 pores per inch.

9. The whiteboard eraser of claim 8, wherein the reticulated scrubbing portion defines a pore count of not more than 25 pores per inch.

10. The whiteboard eraser of claim 9, wherein the reticulated scrubbing portion defines a pore count of not more than 15 pores per inch.

11. The whiteboard eraser of claim 1, wherein the reticulated scrubbing portion material is constructed of one or more of the materials from the group consisting of: polypropylene, polyethylene, polyurethane, and nylon.

12. The whiteboard eraser of claim 1, wherein the reticulated scrubbing portion is constructed of plastic or elastomeric material.

13. A whiteboard eraser comprising:
a first side defining a grip surface; and
a second side defining an eraser surface,
wherein the eraser surface comprises a textile wiping portion and a reticulated scrubbing portion more abrasive than the textile wiping portion.

14. The whiteboard eraser of claim 13, wherein the textile wiping portion and the reticulated scrubbing portion are provided in disparate zones on the eraser surface.

15. The whiteboard eraser of claim 14, wherein the disparate zones include a first zone of the textile wiping portion forming a perimeter around a second zone of the reticulated scrubbing portion.

16. The whiteboard eraser of claim 15, wherein the first zone has a greater surface area than the second zone.

17. The whiteboard eraser of claim 13, wherein the textile wiping portion is constructed of one or more of the materials from the group consisting of: felt, wool, synthetic wool, or microfiber.

18. The whiteboard eraser of claim 13, wherein the reticulated scrubbing portion is constructed of plastic foam material.

19. The whiteboard eraser of claim 13, wherein the reticulated scrubbing portion defines a face that protrudes from a face defined by the textile wiping portion.

20. The whiteboard eraser of claim 13, wherein the reticulated scrubbing portion defines a pore count of 5 to 125 pores per inch.

21. The whiteboard eraser of claim 20, wherein the reticulated scrubbing portion defines a pore count of not more than 25 pores per inch.

22. The whiteboard eraser of claim 21, wherein the reticulated scrubbing portion defines a pore count of not more than 15 pores per inch.

23. The whiteboard eraser of claim 13, wherein the reticulated scrubbing portion is constructed of one or more of the materials from the group consisting of: polypropylene, polyethylene, polyurethane, and nylon.

24. The whiteboard eraser of claim 13, wherein the reticulated scrubbing portion is constructed of plastic or elastomeric material.
